(19) United States
(12) Patent Application Publication
(10) Pub. No.: US 2003/0204411 A1
(43) Pub. Date: Oct. 30, 2003

(54) Medical security system

(75) Inventor: Friedhelm Beyersdorf, Freiburg (DE)

Correspondence Address: Schuster & Partner, Wiederholdstrasse 10, D-70174 Stuttgart, DE

(73) Assignee: Universitatsklinikum Freiburg

(21) Appl. No.: 10/128,666

(22) Filed: Apr. 24, 2002

(51) Int. Cl. G06F 17/60

(52) U.S. Cl. 705/2

(57) ABSTRACT

A method for preparing a patient for a medically indicated procedure such as an operation, is presented with which steps necessary for the procedure are checked and the completion of those steps verified. The method proceeds by generating a list of tasks to be carried out and a list of preparatory items in association with those tasks. Data are entered in response to prompts for the list of preparatory items and a list of tasks and of preparatory items is updated appropriately in response to that data input. This feedback looping process continues until a closed matrix of accomplished items and tasks is presented to the system and the system indicates that the patient is ready of the indicated procedure. The invention has the advantage of increased efficiency by precluding the necessity for personnel not normally responsible for a given task or item, from having to carry that item out, when it was omitted in a previous processing stage.

### BACKGROUND OF THE INVENTION

The invention concerns a method for preparing a patient for a medically indicated procedure and for checking whether or not all steps necessary for that procedure have been taken.

World health service systems operate in a manner in which patients are prepared for various procedures, including operations, by checking through lists of particular steps or phases which are to be carried out. For example, prior to carrying out an operation various preparatory actions must be taken which include, for example, routine preliminary examinations of the patient by a doctor, further diagnostic and therapeutic measures for the patient which result from these preliminary examinations and various nursing activities such as shaving the patient, preoperative removal of dentures, jewellery and the like. These steps are usually monitored using a check-list on a paper-based form in which all preparatory steps are listed. However, in the event that an individual step appears to be omitted, it is often difficult to determine whether the step has actually been omitted or whether the form was simply not properly filled out by the person responsible therefor. Moreover, it is not always possible to consult with that person who might be responsible for an incomplete filling out of the form, since the person may not be on the particular shift during which the omission is recognized, be in a different shift or may not be available for other reasons. As a result, the missing steps are simply repeated to the extent possible in the station or location at which the patient is presently found. As a result thereof tests which should have been performed at a previous station, for example ECG, blood tests and so on, must be carried out at a later station e.g. by an anesthesiologist or a surgeon. This subsequent processing is inefficient and leads to unnecessary delays. In short, a fixed rigid assignment of responsibilities for examination of the given individual steps to particular stations in the hospital does not occur. This situation also applies to other types of patient interfaces within a hospital such as transfer from the operating room to intensive care, transfer from intensive care to a normal station as well as transfer from the normal station back to the patient's home or to another hospital.

In consequence of the above described status of prior art and the inefficiencies associated therewith, it is the underlying purpose of the present invention to develop and improve a patient monitoring system with which items which are to be performed on the patient can be performed in fixed assignment and updated if necessary such that the omission of steps is extremely unlikely and the necessity of subsequent stations having to carry out steps which should have been performed previously is substantially precluded.

### SUMMARY OF THE INVENTION

This purpose of the invention is achieved with a method for preparing a patient for a medically indicated procedure and for checking whether or not all steps necessary for the procedure have been taken, the method comprising the steps of:

a) generating a list of tasks to be carried out during the procedure;

b) examining step a) to determine a list of preparatory items to be carried out prior to those tasks;

c) extracting data in response to results of said preparatory items of step b);

d) examining said data of step c) to decide if a modification in a number and a sequence of said tasks of step a) is required, changing that list of tasks accordingly, and repeating steps a) to d);

e) examining said data of step c) to decide if a modification in a number and sequence of said preparatory items in step b) is required, changing that list of items accordingly and repeating steps b) to e);

f) examining said items of step b) to determine whether or not additional changes in step a) and step b) are required and repeating steps a) to f) accordingly; and

g) indicating readiness for the medically indicated procedure.

The invention is particularly suited for detecting steps required prior to an operation, during an operation, during an intensive care and even during a stay in a normal station as well as for checking associated tasks. After entry of the patient data, a list of steps and requests is automatically produced which is adjusted to the patient and which does not contain any superfluous or unnecessary requests. When input requires further steps, e.g. additional examinations, the list is automatically extended. There is therefore an interaction between the entries and the tasks and items listed. The requested statements or answers are entered into a computer or a computer network and are stored in an external memory means or in a memory which can be accessed via that computer network. Critical statements or statements which render an operation impossible are correspondingly marked on a display device of the computer. The patient is admitted to an operation only when all tasks have been positively concluded. Checking is facilitated by an optical or acoustical display on the computer or by a specially provided device when a completed positive filling in of the list obtains. Devices for examining the statements in the list and for indicating and displaying admittance or rejection can e.g. be provided in the entry region of the operating room. For example, a green light can signal admittance and a red light rejection. A correspondingly extended or supplemental list can be kept during and after the operation and up to release of the patient from the clinic. The invention permits the generation of software which can be coupled to hardware for generating acoustical signals, optical signals or even for locking and opening doors. Moreover, a chip card, a transponder or a disc can be provided for storing statements. The patient can also be identified by a PIN (personal identification number), through biometric recognition features, or via barcode and can be associated with data stored in the memory of a computer network system.

The invention therefore provides for a path of a patient through a hospital, from reception to the normal station, to an operating station and to an intensive care as well as back to the normal station and then on to release, which can abstractly be viewed as a sequence of steps such as those carried out in industrial mass production (e.g. car or plane production). In such industrial mass production processes a subsequent step can be initiated only after completion of the previous step. At the end of a previous step, an automatic check is performed for completeness before initiating the next step. Correction for previous work or subsequent performance thereof which belongs to a previous step is not carried out in a following step. The work and checks are performed with the assistance of software programs which can be coupled to corresponding hardware. The system is therefore maximized for efficiency and avoids the necessity that steps, which should have been previously carried out, be carried out in a subsequent station.

In a preferred embodiment of the invention the medically indicated monitored procedure is a surgical procedure. This embodiment has the advantage of utilizing the invention for procedures in which a complicated interactive system of checks and balances is required to track couplings existing between the procedures which are to be carried out and the results of previous tests.

In a variation of this preferred embodiment, the surgical procedure is a heart surgery procedure. This feature has the advantage of applying the series of checks and balances to an extremely critical surgical procedure involving complicated combinations of tasks and items which must be monitored and checked carefully in order to assure that risk to the patient is minimized.

In an embodiment of this variation the list of tasks which are to be carried out includes a by-pass procedure. This embodiment has the advantage of applying the method to a common procedure in modern medicine.

In a preferred embodiment of the invention, the method comprises a step of displaying the lists of tasks and the list of preparatory items on a computer monitor. This embodiment has the advantage of utilizing current technology for carrying out the method, wherein computer systems can also be networked to each other such that common information is available at a plurality of locations.

In a preferred embodiment of the method, a patient status indication is output and updated. This embodiment has the advantage of providing a quick and easy reference as to an overall status of the patient without requiring detailed analysis of the entire data contents. In a preferred variation of this embodiment, the status indication is optical thereby providing for a quick reference which a user can easily recognize. Alternatively, or in addition thereto, the status of indication feature is acoustical. This provides for an indication of the status of the patient independent of whether or not the medical personal is directing his or her visual attention towards a monitor screen.

In an additional preferred embodiment, the status information is coupled to at least one hardware device, such as a door locking means. This variation has the advantage of prohibiting or allowing access to a different station depending on the status of the preparation procedures.

In a further preferred embodiment, the status indication comprises at least two status categories such as a stop indication and a go indication. This variation has the advantage of providing an extremely quick overall global directive to the user without requiring detailed analysis of the data involved in the tasks and items to be carried out. Preferably, one status indication uses a first color such as red (stop) and the other status indication uses a second color such as green (go). This variation of the preferred embodiment has the advantage of applying conventionally recognized traffic signals to indicate the status of the patient.

In a further preferred embodiment of the invention, the list of items is stored on a chip card member or a transponder means. This embodiment has the advantage of facilitating the transfer of information along with the patient (i.e. to a different hospital) using simple and straight forward techniques.

In an additional preferred embodiment, the patient is assigned a personal identification number, a biometric recognition feature or a barcode. This embodiment advantageously provides for unique computer recognizable identification of a patient file.

In a highly preferred embodiment of the invention, the user can define different safety levels. For embodiments of the invention in which clearance is signaled through the switching of a “traffic light” from red to green, the user can vary the criteria for which this switching can occur to indicate fulfillment of all requirements prior to an operation. This can be done in dependence on each individual patient, the diagnosis, or the type of operation. Safety levels can be defined according to category such as standard, extra, or special.

The invention further includes a programmable data processing device programmed with instructions for carrying out the method as well as a data storage medium on which such machine readable code is stored, the code being intelligible for that data processing device. This feature of the invention provides for application of the method using modern day computer storage and calculating devices.

Further advantages of the invention can be derived from following features of the drawing. The subsequent discussion of the drawings involves a preferred embodiment of the invention and is not to be considered an exhaustive enumeration of all inventive features. Various features disclosed in the drawing and in the claims as well as in the previous description can be important to the invention either individually or collectively in any arbitrary combination.

### BRIEF DESCRIPTION OF THE DRAWING

FIG. 1 shows a manual driven listing of a planned operation including optional steps which could be carried out during an operation;

FIG. 2 illustrates a list of input data required in preparation for an operation and for carrying out the steps selected from the list of FIG. 1;

FIG. 3 indicates a mask for generating input in response to a list entry number of FIG. 2 (size and weight);

FIG. 4 displays a change in listing in response to a previous entry, automatically extending the list and generating a new sequence of steps;

FIG. 5 is a second example of an automatic update and resequencing of items similar to that of FIG. 4; and

FIG. 6 illustrates a flow-chart of the method according to the invention.

### DETAILED DESCRIPTION OF THE PREFERRED EMBODIMENT

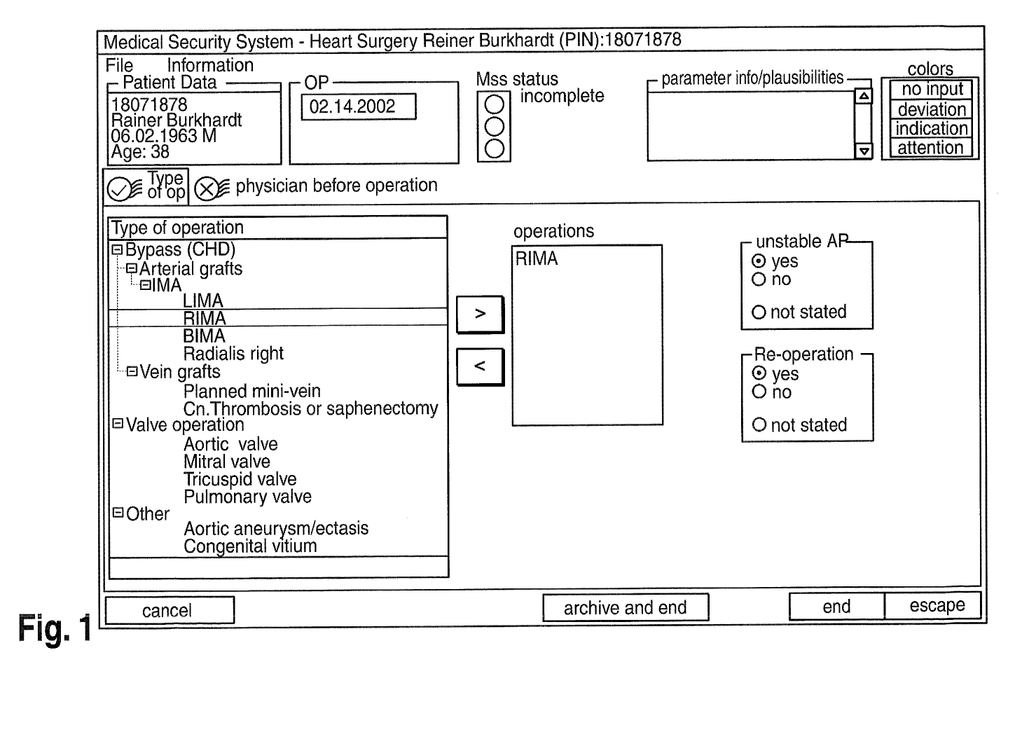

FIG. 1 illustrates a menu driven listing of a planned operation with operation steps which could be carried out during that operation. For the example shown in FIG. 1, the procedures apply to heart surgery. The heart surgery medical security system (MSS) lists a particular patient's name (Rainer Burkhard) having an assigned personal identification number of 18071878. The file information data subsequently lists that patient's number and other important information such as the date of birth, gender, and age. An operation date of Feb. 14, 2002 is also indicated. The traffic light symbol labeled MSS status provides a quick optical indication (red, yellow, green) of whether or not the patient is prepared for surgery. Additional parameter information (indications or plausibilities) is provided as well as a field for colored indication of changes, various indications and particular matters to which attention should be directed. All this information can be displayed on the screen of a computer. Extending down the screen is an outlined list, specifying types of operations. Under the general heading “by-pass operation” options such as arterial graphs IMA and such options as LIMA, RIMA, and BIMA are indicated. In association with the by-pass, vein graphs can be checked or indicated and specifications assigned concerning mini-vein or thrombosis procedures. Valve operation can also be indicated in association with aortic valves, mitral valves, tricuspid valves and pulmonary valves. Other indications are also available, such as aortic aneurysms, ectasis or a congenital vitium. Operations can then be indicated in the field to the right of this list (exemplified by the input RIMA). Further status information for the patient such as whether or not this is the first operation or other unstable indicators can be input and displayed. Cancel, archive and end buttons as well as an escape means are also provided.

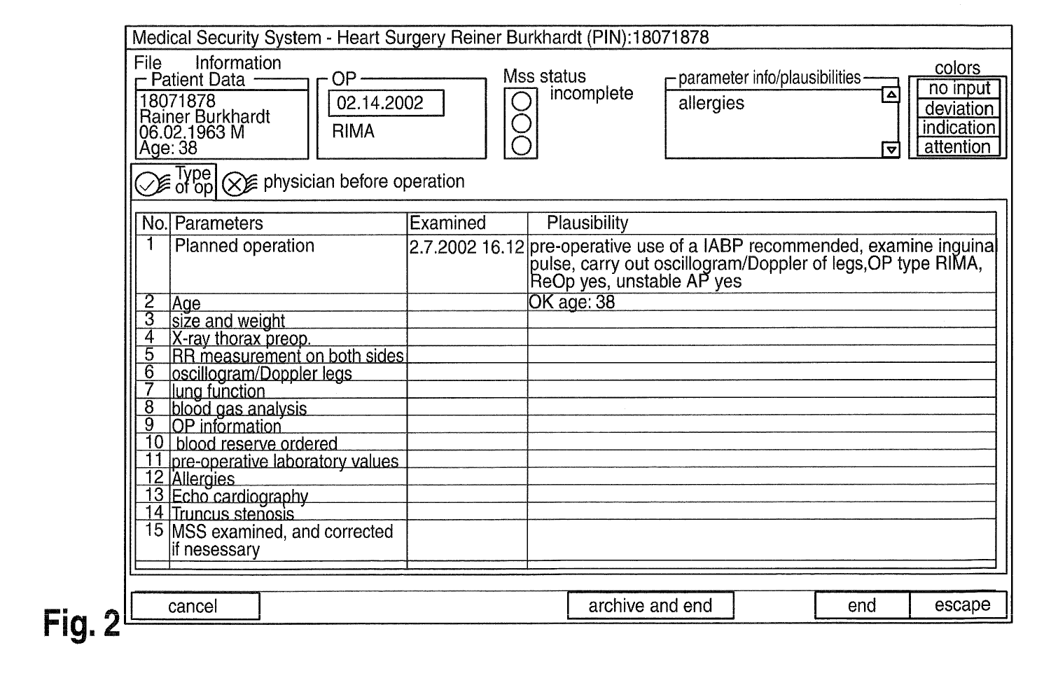

FIG. 2 shows a checklist of procedures and tests which are required prior to carrying out the operations selected in FIG. 1. The list of FIG. 2 is automatically generated according to the method of the invention in preparation for the operation. A field is provided for acceptance of data input. In particular, referring to the list beginning in the portion of the figure following the title information, one sees an assignment list of 15 items (parameter numbers 1 to 15) which are to be carried out. The parameters column indicates, in succession, a planned operation, age, size and weight of the patient, x-ray thorax, RR measurement, oscillograms, lung function, blood gas, OP information, blood reserve status, preoperative laboratory values, allergies, echocardiography, truncus stenosis, and an indication of whether or not the MSS (medical security system) has been examined and corrected if necessary. An examination column indicates an entry or observation on Feb. 7, 2002 at 4:12 pm. The plausibility (indications) lists input associated with the example of the planned operation in parameter 1, with indications being given for preoperative use of IABP, to examine pulse, to carry out an oscillogram/Doppler of the legs, etc. The type of operation is indicated (RIMA) and also the fact that it is a pre-op procedure. An unstable AP is also displayed. The subsequent age entry indicates an age of 38.

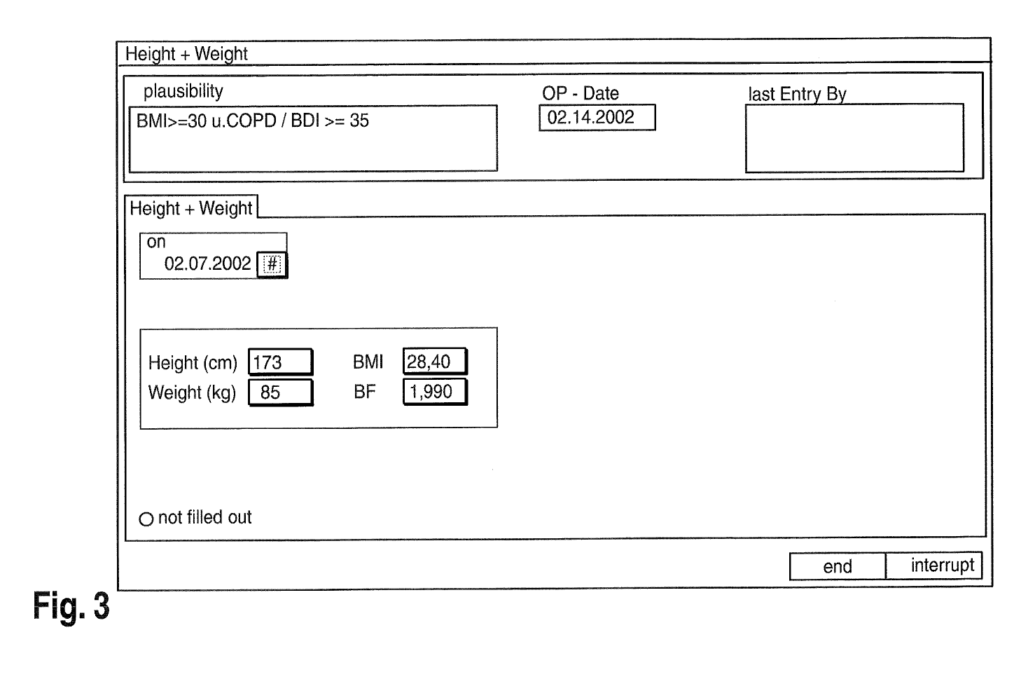

FIG. 3 is an example of a computer generated mask in which data input can be entered in response to selection of a particular list entry number. In particular FIG. 3 corresponds to a mask generated in response to requests for data entry for parameter number 3 of FIG. 2 (size and weight). Indication entries are given at the top as well as the operation date of Feb. 14, 2002. Provision is provided for entry of the name of the person entering the data. The height and weight indicates the measurements were performed on Feb. 7, 2002 with a height of 173 cm and a weight of 85 kg. BMI and BF values are also shown. Provisions are provided for interrupt and end buttons.

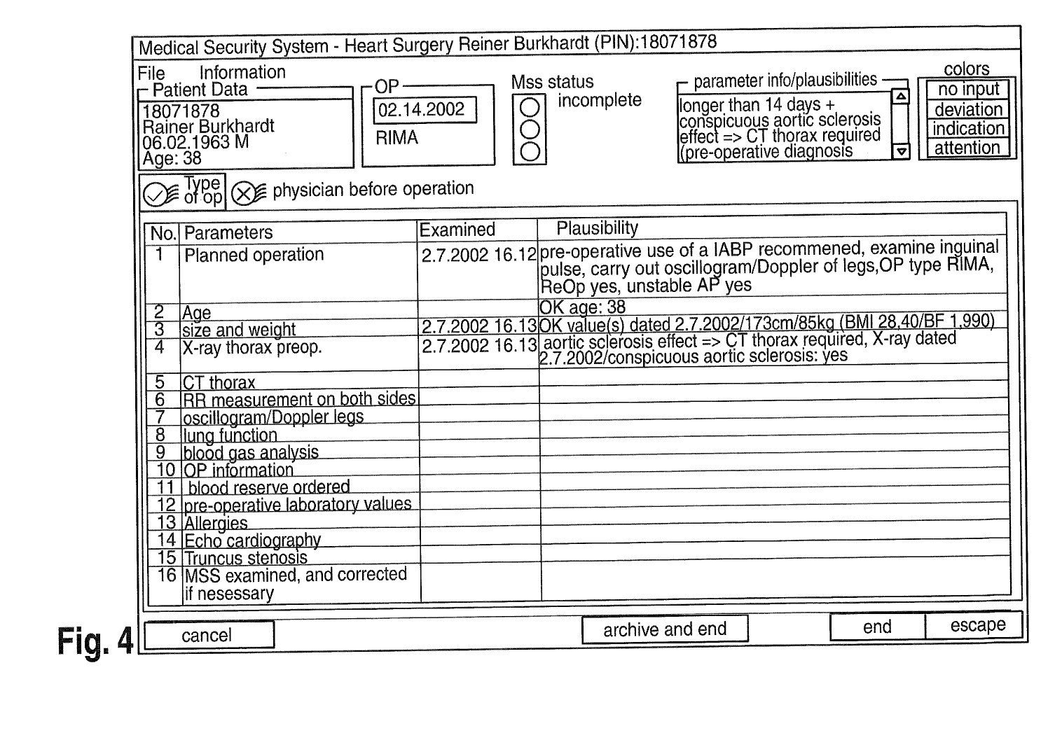

FIG. 4 provides a first example of an interactive change in the list which is dynamically generated in response to a particular input. For the example of FIG. 4, the results of an x-ray thorax indicating aortic scleroses in association with parameter number 4, automatically generates a modification in the list of items by introducing a new required step (CT thorax, new parameter 5). The new step drives a change in sequence of the remaining steps as well as in the overall number of steps which are then automatically updated and sorted in accordance with indications necessitated by the data entry in association with the X-ray thorax. Former steps 5 to 15 are remapped into new steps 6 through 16 respectively.

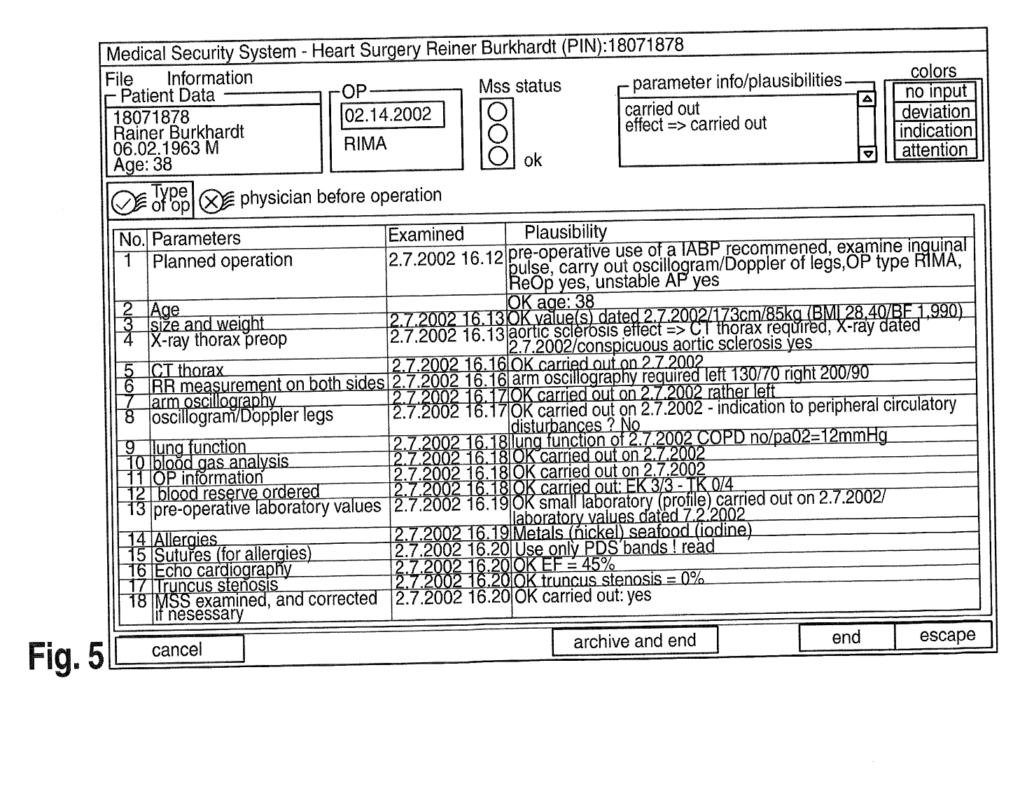

A second example of such an updating procedure is given in FIG. 5. In this particular case, a subsequent entry of left and right deviating RR measurements (in parameter 4) automatically leads to a sequence change with a new step being introduced indicating arm oscillography (new step 7). Former steps 7 to 13 in FIG. 4 have been remapped to new steps 8 to 14. Likewise, an entry in the response to “allergies” of parameter 14 leads to generation of a new step ‘sutures’ directing personal to specific suture limitations (PDS bands). In the example of FIG. 5, the MSS status traffic light type symbol at the upper middle portion of the figure indicates a status of okay, wherein the medical security system provides clearance for carrying out the operation.

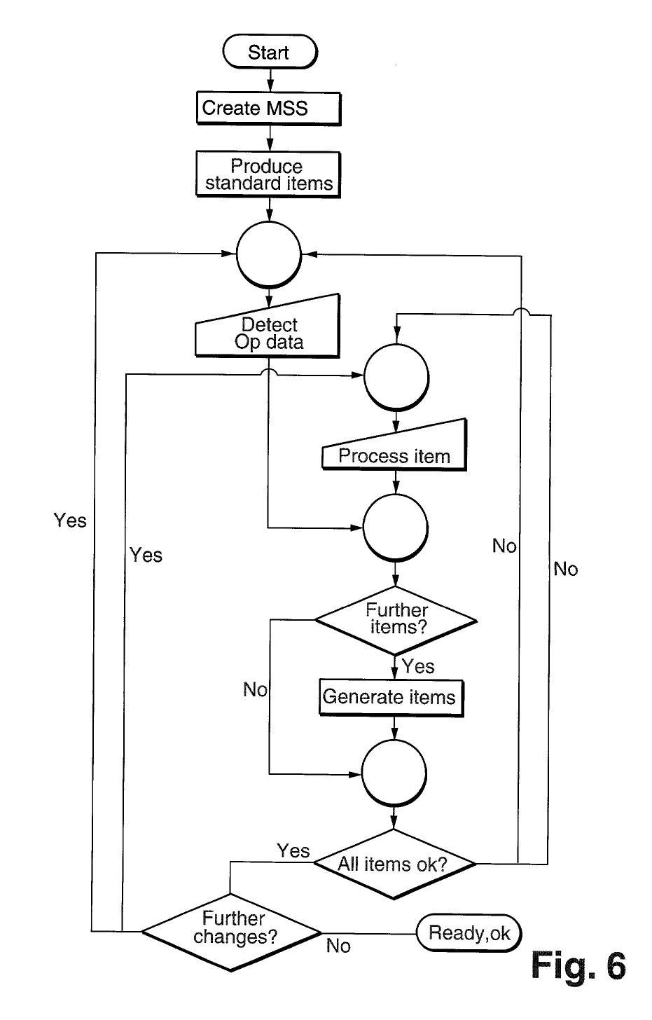

FIG. 6 is a flow-chart of the method in accordance with the invention. In an embodiment in which the invention is carried out with the assistance of a computer program, the program begins by creating a medical security system file. A list of standard items, such as planned operations, and the steps involved therein is produced in an initial step and data are input according to the procedure desired. In a subsequent step, that data is analyzed and a list of items to be carried out is generated. An inquiry stage requests enter of further items. If further items are desired, those items are generated in a separate step, otherwise the processing continues. In response to the input of data an evaluation step analyses previous data input. Should this evaluation of the item list and the associated data inputs indicate that further changes in either the operation procedures or the preparatory items is necessary, control passes back to the appropriate upstream location and the process is repeated. If all items appear to be in a satisfactory state a last inquiry scans through the entire matrix of items and procedures to check for mutual consistency and, when appropriate, issues an indication that the patient is ready for the procedure.

I claim:

1. A method for preparing a patient for a medically indicated procedure and for checking whether or not all steps necessary for that procedure have been taken, the method comprising the steps of:
a) generating a list of tasks to be carried out during the procedure;
b) examining step a) to determine a list of preparatory items to be carried out prior to said tasks of step a);
c) extracting data in response to results of said preparatory items of step b);
d) examining said data of step c) to decide if a modification in a number and sequence of said tasks of step a) is required, changing that list of tasks accordingly, and repeating steps a) to d);
e) examining said data of step c) to decide if a modification in a number and a sequence of said preparatory items of step b) is required, changing that list of items accordingly and repeating steps b) to e);
f) examining said items of step b) to determine whether or not additional changes in step a) and step b) are required and repeating steps a) to f) accordingly; and
g) indicating readiness for the medically indicated procedure.

2. The method of claim 1, wherein the medically indicating procedure is a surgical procedure.

3. The method of claim 2, wherein said surgical procedure is a heart surgery procedure.

4. The method of claim 3, wherein said list of tasks comprises a bypass procedure.

5. The method of claim 4, wherein said list of tasks comprises arterial graphs.

6. The method of claim 5, wherein said list of tasks comprises at least one of LIMA, RIMA, BIMA, and radialus.

7. The method of claim 6, wherein said list of tasks comprises vein graphs.

8. The method of claim 7, wherein said list of tasks comprises at least one of mini veins, CN thrombosis and saphenectony.

9. The method of claim 3, wherein said list of tasks comprises a valve operation.

10. The method of claim 9, wherein said list of tasks comprises at least one of an aortic valve, a mitral valve, a tricuspid valve and a pulmonary valve.

11. The method of claim 3, wherein said list of tasks comprises at least one of aortic aneurysm, ectasis, and congenital vitium.

12. The method of claim 2, wherein said list of preparatory items includes at least one of a planned operation, age, size, weight, RR measurement, oscillogram/Doppler, lung function, blood gas analysis, OP information, blood reserve status, preoperative laboratory values, allergies, echocardiography and truncus stenosis.

13. The method of claim 1, further comprising the step of displaying said list of tasks and said list of preparatory items on a computer monitor.

14. The method of claim 1, further comprising outputting and updating a patient status indication.

15. The method of claim 14, wherein said status indication is optical.

16. The method of claim 14, wherein said status indication is acoustical.

17. The method of claim 14, further comprising coupling said status information to at least one hardware device.

18. The method of claim 17, wherein said hardware device is a door locking means.

19. The method of claim 14, wherein said status indication comprise at least two status categories.

20. The method of claim 19, wherein said at least two status categories comprise a stop indication and a go indication.

21. The method of claim 20, further comprising assigning and displaying a first color corresponding to said stop indication and a second color corresponding to said go indication.

22. The method of claim 21, wherein said first color is red and said second color is green.

23. The method of claim 1, further comprising storing said list of items on one of a chip card member and transponder means.

24. The method of claim 1, further comprising assigning at least one of a personal identification number, a biometric recognition feature, and a barcode to the patient.

25. A programmable data processing device programmed with instructions for carrying out the method of claim 1.

26. A data storage medium on which machine readable code is stored, that code being intelligible to the data processing device of claim 25.
